(19) United States
(12) Patent Application Publication
(10) Pub. No.: US 2007/0277985 A1
(43) Pub. Date: Dec. 6, 2007

(54) Vibrating Sod Cutter Attachment For Landscaping Implement

(76) Inventors: Raymond C. Hager, Mankato, MN (US); Sydney A. Hager, Waseca, MN (US)

Correspondence Address: Moore & Hansen, PLLP, Suite 4850, 225 South Sixth Street, Minneapolis, MN, 55402, US

(21) Appl. No.: 11/689,176

(22) Filed: Mar. 21, 2007

Related U.S. Application Data
(60) Provisional application No. 60/784,339, filed on Mar. 21, 2006.

(51) Int. Cl. A01B 45/04

(52) U.S. Cl. 172/19; 60/325

(57) ABSTRACT

A sod cutting arrangement is mounted on a motorized implement, such as a walk-behind compact utility loader. The sod cutting arrangement incorporates a vibrating cutting head that may be driven by a hydraulic motor. A motion limiting arrangement may limit travel of the vibrating cutting head in both forward and reverse directions.

### TECHNICAL BACKGROUND

The disclosure relates generally to earth working equipment. More particularly, the disclosure relates to equipment for cutting sod.

### BACKGROUND

In the context of residential or commercial construction, it is often desirable and sometimes required to remove or replace grass sod for any of a number of reasons. For example, in new construction, it may be desirable to incorporate grass into the area immediately surrounding new buildings. In the context of landscaping existing yards or sports fields it may also be desirable to replace grass that has been damaged by disease or drought or simply remove grass when other surface features, such as plants or flower beds, are desired. In some cases where construction work involves disturbing otherwise healthy grass by trenching through it or moving equipment across it, it may be desirable to cut out the existing sod, roll it up, and set it aside. In this way, once the construction work is completed, the retained sod can be replaced.

Several techniques are known for adding grass. For example, new grass can be grown by seeding or hydroseeding processes. As another example, grass can be incorporated into the area by laying down sod. This approach may be preferable in some scenarios because it avoids the need to wait for the grass to grow from seeds. As a result, the property owner and other persons can immediately appreciate the appearance of grass. Where there are existing grasses that need to be replaced or removed, one approach involves cutting the grass out by severing the roots from the underlying soil and then removing the organic material that would otherwise cause clumps and generally interfere with creating a smoothed soil surface for seeding or laying new sod.

Sod can be harvested from existing grassland by cutting the sod from the grassland. The sod may then be rolled into strips or cut into squares or other shapes for application to the desired location. A number of sod cutting devices are known in the art. Many of these devices employ cutting heads that reciprocate back and forth to separate the harvested sod from the grassland. Further, in some sod cutting devices, the cutting head is rigidly linked to a vibrating mechanism so that the cutting head itself vibrates. The rigid link may be accomplished, for example, via a Pittman arm arrangement or a crankshaft and connecting rod. While rigidly linking the cutting head to a vibrating mechanism will cause it to vibrate, the linkage is susceptible to mechanical failure and must be repaired or replaced periodically. In addition, many conventional sod cutting devices are standalone machines that can be relatively expensive.

### SUMMARY OF THE DISCLOSURE

According to various example embodiments, a sod cutting arrangement is mounted on a motorized implement, such as a walk-behind compact utility loader. The sod cutting arrangement incorporates a vibrating cutting head that may be driven by a hydraulic motor. A motion limiting arrangement may limit travel of the vibrating cutting head in both forward and reverse directions.

One embodiment is directed to a sod cutting apparatus for use with a motorized implement, such as a compact utility loader or a skid-steer loader. The sod cutting apparatus includes a mounting plate sized and configured to be attachable to the motorized implement. A hydraulic motor is configured to be coupled to the hydraulic fluid output. An unbalanced vibrator shaft is coupled to the hydraulic motor and is configured to generate a vibration when the hydraulic motor is energized. A cutting blade is operatively coupled to the vibrator shaft.

Another embodiment is directed to a vibratory apparatus for use with a motorized implement having a hydraulic fluid output. The vibratory apparatus comprises a mounting plate sized and configured to be attachable to the motorized implement. Hydraulic motors are configured to be coupled in parallel to the hydraulic fluid output. Unbalanced vibrator shafts are coupled to the hydraulic motors and are configured to generate oscillatory vibrations when the hydraulic motors are energized. A timing chain synchronizes the vibrator shafts when the vibrator shafts move out of synchronization. A tool, such as a sod cutting blade, is operatively coupled to at least one of the vibrator shafts.

In yet another embodiment, a vibratory apparatus for use with a motorized implement having a hydraulic fluid output includes a mounting plate sized and configured to be attachable to the motorized implement. A hydraulic motor is configured to be coupled to the hydraulic fluid output. An unbalanced vibrator shaft is coupled to the hydraulic motor and is configured to generate an oscillatory vibration when the hydraulic motor is energized. A tool carriage assembly is coupled to the vibrator shaft and arranged to vibrate when the vibrator shaft vibrates. A tool is coupled to the tool carriage assembly and is arranged to vibrate when the tool carriage assembly vibrates.

Various embodiments may provide certain advantages. For instance, the vibrating sod cutter attachment disclosed herein avoids the need for a mechanical linkage to cause the cutting head to vibrate. As a result, the sod cutter attachment may be relatively less susceptible to mechanical failures than conventional sod cutting devices that employ a mechanical linkage. In addition, the vibrating sod cutter attachment is mounted to a motorized landscaping implement, such as a walk-behind compact utility loader, and potentially saves the user the additional expense associated with a standalone sod cutting apparatus.

Additional objects, advantages, and features will become apparent from the following description and the claims that follow, considered in conjunction with the accompanying drawings.

### BRIEF DESCRIPTION OF THE DRAWINGS

FIG. 1 illustrates a sod cutting apparatus according to one embodiment.

FIG. 2 is a side view of the sod cutting apparatus of FIG. 1.

FIG. 3 is a plan view of an alternative implementation of the sod cutting apparatus according to another embodiment.

FIG. 4 illustrates a vibrating mechanism forming a portion of the sod cutting apparatus of FIG. 1.

FIG. 5 illustrates a travel limiting mechanism forming a portion of the sod cutting apparatus of FIG. 1.

### DESCRIPTION OF VARIOUS EMBODIMENTS

According to various example embodiments, a sod cutting arrangement is mounted on a motorized implement, such as a walk-behind compact utility loader. The sod cutting arrangement incorporates a vibrating cutting head that may be driven by a hydraulic motor. A motion limiting arrangement may limit travel of the vibrating cutting head in both forward and reverse directions.

The following description of various embodiments implemented in a front end loader is to be construed by way of illustration rather than limitation. This description is not intended to limit the invention or its applications or uses. For example, while various embodiments are described as being implemented as attachments for use with a compact utility loader, it will be appreciated that the principles of the disclosure are applicable to sod cutting apparatuses operable in other environments, such as skid-steer loaders or other motorized landscaping implements.

In the following description, numerous specific details are set forth in order to provide a thorough understanding of various embodiments. It will be apparent to one skilled in the art that some embodiments may be practiced without some or all of these specific details. In other instances, well known components and process steps have not been described in detail.

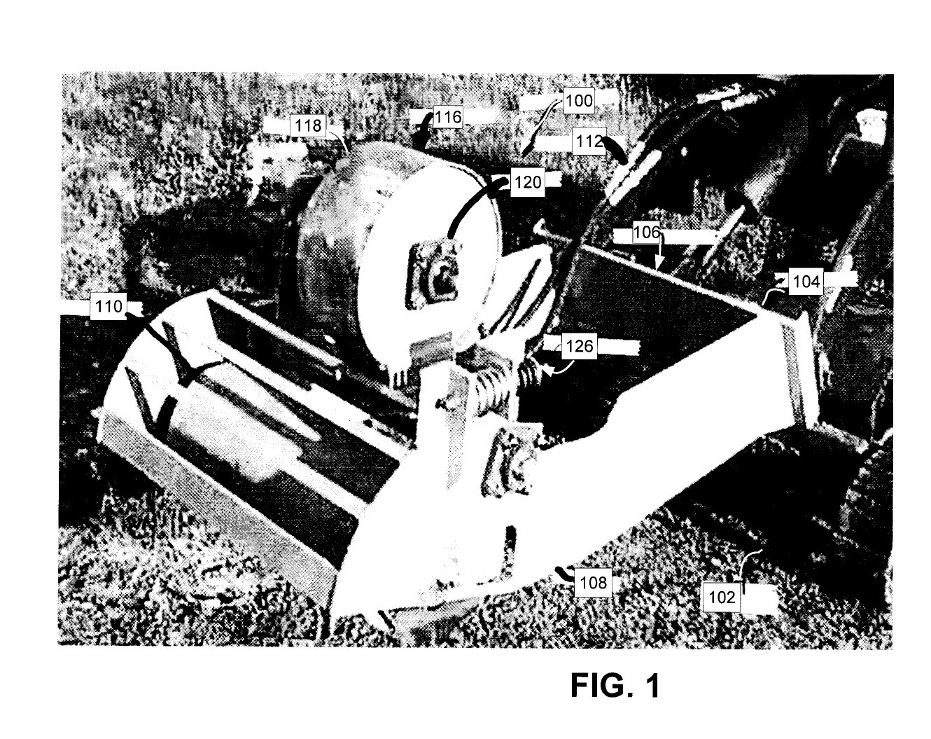

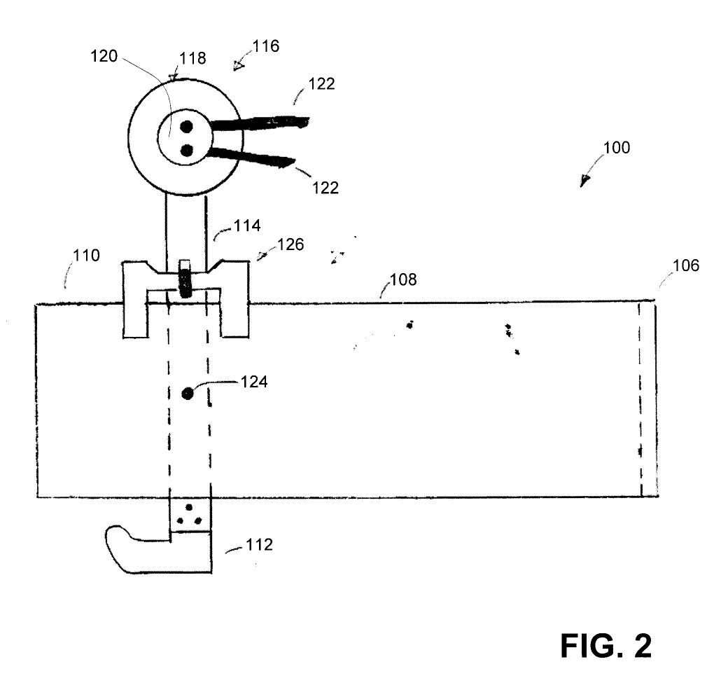

Referring now to the drawings, FIG. 1 illustrates a perspective view of a sod cutting apparatus 100 according to one embodiment. FIG. 2 is a side view of the sod cutting apparatus 100. A motorized implement, illustrated in FIG. 1 as a compact utility loader 102, has one or more universal attachment brackets 104 that are designed to accommodate a variety of tools. For example, the DINGO series compact utility loaders commercially available from The Toro Company of Bloomington, Minn., can accommodate a variety of buckets, auger power heads, and other tools mounted on the front of the compact utility loader 102. As another example, the motorized implement may be embodied as a skid-steer loader, such as a BOBCAT skid-steer loader, commercially available from Bobcat Company of West Fargo, N.Dak.

The sod cutting apparatus 100 is mounted to the universal attachment bracket 104 via a meeting plate 106. Because the meeting plate 106 is compatible with the universal attachment bracket 104, the sod cutting apparatus 100 can be used with any of a variety of motorized implements that have a universal attachment bracket 104, including, but not limited to, compact utility loaders and skid-steer loaders available from manufacturers other than those listed above, as well as other types of motorized implements, such as compact track loaders and all-wheel steer loaders.

The sod cutting apparatus 100 includes frame arms 108 that extend from the meeting plate 106. The frame arms 108 are spaced apart from one another at a distance sufficient to accommodate a roller 110 for limiting the depth to which the sod is cut. In one embodiment, for example, the roller 110 is formed from a tube 16¾″ in length disposed between end plates that are spaced 17″ apart. In this embodiment, the frame arms 108 are spaced apart at a distance of 20½″ to allow a 1¾″ gap between the end plates and the frame arms 108. A roller 108 located at an end of the sod cutting apparatus 100 that is distal from the meeting plate 106. It will be appreciated by those of skill in the art that the width of the roller 110 need not be as specified herein, and is limited only by the ability of the universal attachment bracket 104 to support the sod cutting apparatus 100.

As shown in FIG. 2, a cutting blade 112 is mounted under the frame arms 108 such that the cutting blade 112 engages the grassland when the sod cutting apparatus 100 is in operation. The cutting blade 112 has a width that is selected to fit between a pair of blade side knife plates with approximately ½″ clearance on each side. In the example embodiment described herein, the cutting blade 112 is 18″ wide. The width of the cutting blade 112 determines the width of the sod strips that are cut when the sod cutting apparatus 100 is in operation. The cutting blade 112 is mounted to one end of a blade carriage assembly 114. Mounted at the other end of the blade carriage assembly 114 is a vibrator arrangement 116 housed within a vibrator shroud 118. The vibrator arrangement 116 includes a hydraulic motor 120. The hydraulic motor 120 is powered by the auxiliary hydraulic output of the compact utility loader 102 via flexible hydraulic fluid lines 122.

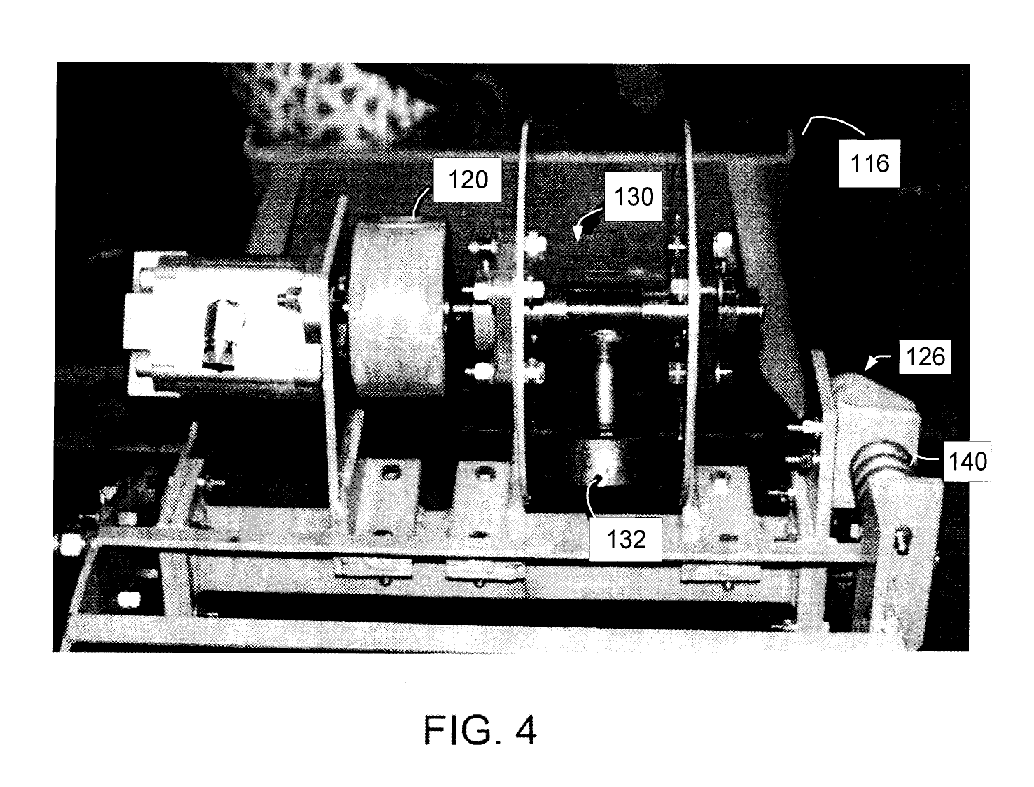

When the hydraulic motor 120 is energized, the hydraulic motor 120 drives a vibrator shaft (not visible in FIGS. 1 and 2). FIG. 4 illustrates one embodiment of a vibrator shaft 130. A weight 132 is located along the vibrator shaft 130 at a position such that the center of gravity of the weight is displaced from the center of the vibrator shaft 130. As a result, the vibrator shaft 130 is unbalanced; that is, the weight of the vibrator shaft 130 is unevenly distributed along the length of the vibrator shaft 130. With the vibrator shaft 130 thus unbalanced, the vibrator arrangement 116 vibrates when the hydraulic motor 120 is energized to drive the vibrator shaft 130. Because the blade carriage assembly 114 is attached to the vibrator shaft 130, the blade carriage assembly 114 and the cutting blade 112, which is attached to the blade carriage assembly 114, also vibrate. In particular, the blade carriage assembly 114 vibrates about a pivot point 124 at which the blade carriage assembly 114 is attached to the frame of the sod cutting apparatus 100. In this way, the vibrator arrangement 116 achieves this mechanical vibration without using a Pittman arm arrangement or a crankshaft and connecting rod. As a result, the vibrator arrangement 116 may be less susceptible to mechanical failure relative to some conventional vibrator arrangements that use a Pittman arm arrangement or a crankshaft and connecting rod.

As an alternative, the vibrator arrangement 116 may employ multiple hydraulic motors 120 and multiple vibrator shafts 130. In this arrangement, driven by the hydraulic motors 120, the weights counter rotate and cause the blade carriage assembly 114 and the cutting blade 112 to vibrate substantially in a single plane. More specifically, the rotation cycles of the weights are synchronized such that the vibration forces from the weights are additive in one plane—the plane of maximum vibration, e.g., corresponding to forward and backward movement of the cutting blade 112. On the other hand, in a plane perpendicular to the plane of maximum vibration, e.g., corresponding to vertical movement of the cutting blade 112, the vibration forces from the weights are subtractive and counteract each other. As a result, very little vibration occurs in the plane perpendicular to the plane of maximum vibration.

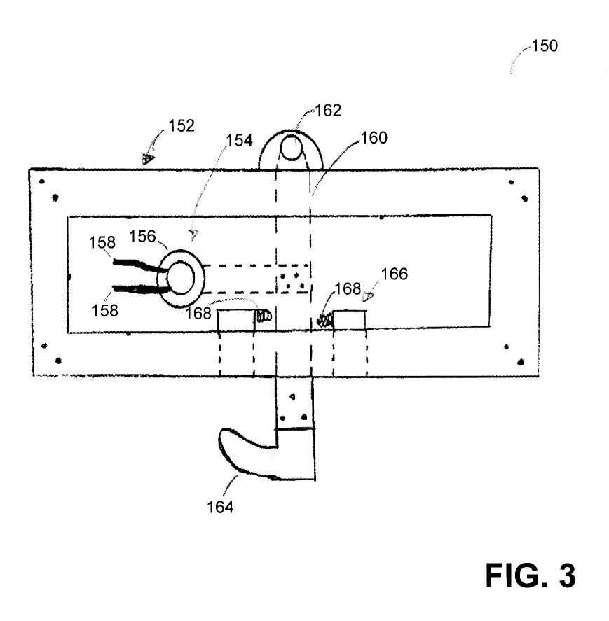

The rotation cycles of the weights are synchronized as a result of at least two factors. First, the blade carriage assembly 114 is mechanically restricted from movement in the vertical plane by the pivot point of attachment of the blade carriage assembly 114 to the frame of the sod cutting apparatus 100. Second, the feed of hydraulic fluid to the hydraulic motors 120 is arranged in parallel such that, due to the inertial forces acting on the unbalanced shafts 130 and the effect of gravity, the shafts 130 create a vibration in the vertical plane and synchronize with each other. This phenomenon may offer certain benefits in applications in which the vibration in the vertical plane can be used directly or converted to horizontal motion, such as the sod cutting apparatus 150 of FIG. 3.

As another alternative, the vibrator shafts 130 can be synchronized using a timing chain. In this embodiment, the timing chain need not be used to drive either of the vibrator shafts 130, but is rather used only to correct instances of the vibrator shafts 130 moving out of synchronization with each other. A further advantage that may be realized by this embodiment is that movement in the plane of minimum vibration would not need to be mechanically constrained. Indeed, this advantage may extend beyond sod cutting apparatuses to any of a variety of vibratory apparatuses that employ an oscillatory motion rather than an orbital motion. In such apparatuses, reducing vibration in the vertical plane may allow the apparatus to operate more smoothly and drive larger loads more efficiently. Moreover, the need for synchronization gears characteristic of certain conventional vibratory apparatuses may be eliminated, thereby simplifying the design and manufacturing processes and reducing costs.

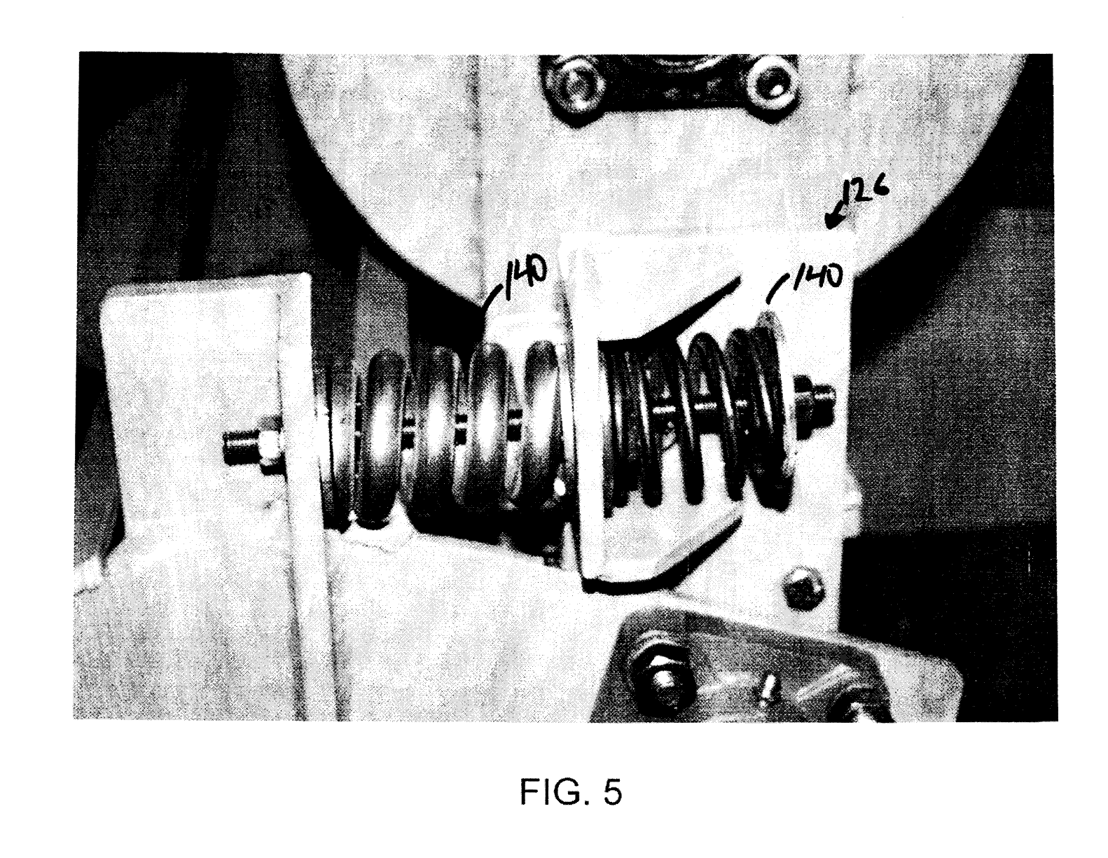

In order to maintain the cutting blade 112 in the proper orientation, a travel limiting arrangement 126 may constrain movement of the cutting blade 112. In one embodiment, shown in FIG. 5, the travel limiting arrangement 126 includes a pair of centering springs 140. As an alternative, the travel limiting arrangement 126 may incorporate elastomeric bumpers (not shown in FIG. 5) in addition to or instead of the centering springs 140.

FIG. 3 illustrates another embodiment of a sod cutting apparatus 150 that attaches to a side of a motorized implement at a suitable location generally designated by reference numeral 152. In the sod cutting apparatus 150 of FIG. 3, a vibrator arrangement 154 includes a hydraulic motor 156 that is fed by hydraulic fluid lines 158 connected to auxiliary hydraulic outputs of the motorized implement. The hydraulic motor 156 drives an unbalanced vibrator shaft (not visible in FIG. 3), which in turn causes a blade carriage assembly 160 to vibrate about a pivot point 162 at which the blade carriage assembly 160 is attached to the frame of the sod cutting apparatus 150. A cutting blade 164 is attached to the blade carriage assembly 160 and vibrates with the blade carriage assembly 160. Movement of the cutting blade 164 is constrained by a travel limiting arrangement 166, which in the embodiment shown in FIG. 3 includes a pair of centering springs 168.

As demonstrated by the foregoing discussion, various embodiments may provide certain advantages, particularly in the context of landscaping applications. For instance, the vibration of the sod cutting blade is achieved without using a Pittman arm arrangement or a crankshaft and connecting rod. As a result, the assembly is less susceptible to mechanical failure.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A sod cutting apparatus for use with a motorized implement having a hydraulic fluid output, the sod cutting apparatus comprising:
a mounting plate sized and configured to be attachable to the motorized implement;
a hydraulic motor configured to be coupled to the hydraulic fluid output;
an unbalanced vibrator shaft coupled to the hydraulic motor and configured to generate a vibration when the hydraulic motor is energized; and
a cutting blade operatively coupled to the vibrator shaft.

2. The sod cutting apparatus of claim 1, further comprising a travel limiting arrangement configured and arranged to constrain motion of the cutting blade in at least one direction.

3. The sod cutting apparatus of claim 2, wherein the travel limiting arrangement comprises a plurality of springs.

4. The sod cutting apparatus of claim 2, wherein the travel limiting arrangement comprises an elastomeric bumper.

5. The sod cutting apparatus of claim 1, further comprising a blade carriage assembly coupled to the cutting blade and to the vibrator shaft.

6. The sod cutting apparatus of claim 5, further comprising a frame attached to the mounting plate and having a pivot point, wherein the blade carriage assembly is attached to the frame at the pivot point and vibrates about the pivot point.

7. The sod cutting apparatus of claim 1, further comprising a plurality of hydraulic motors associated with a plurality of vibrator shafts.

8. The sod cutting apparatus of claim 7, wherein the vibrator shafts comprise weights, and wherein the weights are configured to counter rotate with respect to one another.

9. The sod cutting apparatus of claim 8, further comprising a timing chain configured and arranged to synchronize the vibrator shafts.

10. The sod cutting apparatus of claim 1, wherein the motorized implement is a skid-steer loader.

11. The sod cutting apparatus of claim 1, wherein the motorized implement is a walk-behind compact utility loader.

12. A vibratory apparatus for use with a motorized implement having a hydraulic fluid output, the vibratory apparatus comprising:
a mounting plate sized and configured to be attachable to the motorized implement;
a plurality of hydraulic motors configured to be coupled in parallel to the hydraulic fluid output;
a plurality of unbalanced vibrator shafts coupled to the hydraulic motors and configured to generate oscillatory vibrations when the hydraulic motors are energized;
a timing chain configured and arranged to synchronize the vibrator shafts in response to the vibrator shafts moving out of synchronization; and
a tool operatively coupled to at least one of the vibrator shafts.

13. The vibratory apparatus of claim 12, wherein the tool comprises a sod cutting blade.

14. A vibratory apparatus for use with a motorized implement having a hydraulic fluid output, the vibratory apparatus comprising:
a mounting plate sized and configured to be attachable to the motorized implement;
a hydraulic motor configured to be coupled to the hydraulic fluid output;
an unbalanced vibrator shaft coupled to the hydraulic motor and configured to generate an oscillatory vibration when the hydraulic motor is energized;
a tool carriage assembly coupled to the vibrator shaft and arranged to vibrate when the vibrator shaft vibrates; and
a tool coupled to the tool carriage assembly and arranged to vibrate when the tool carriage assembly vibrates.

15. The vibratory apparatus of claim 14, further comprising a travel limiting arrangement configured and arranged to constrain motion of the cutting blade in at least one direction.

16. The vibratory apparatus of claim 15, wherein the travel limiting arrangement comprises at least one of an elastomeric bumper and a plurality of springs.

17. The vibratory apparatus of claim 14, further comprising a frame attached to the mounting plate and having a pivot point, wherein the tool carriage assembly is attached to the frame at the pivot point and vibrates about the pivot point.

18. The vibratory apparatus of claim 14, wherein the motorized implement is a skid-steer loader.

19. The vibratory apparatus of claim 14, wherein the motorized implement is a walk-behind compact utility loader.

20. The vibratory apparatus of claim 14, wherein the tool is a sod cutting blade.
